(19) United States
(12) Patent Application Publication
(10) Pub. No.: US 2013/0346893 A1
(43) Pub. Date: Dec. 26, 2013

(54) ELECTRONIC DEVICE AND METHOD FOR EDITING DOCUMENT USING THE ELECTRONIC DEVICE

(71) Applicant: FIH (Hong Kong) Limited, Kowloon (HK)

(72) Inventor: CHIH-WEI CHANG, New Taipei (TW)

(21) Appl. No.: 13/906,511

(22) Filed: May 31, 2013

(30) Foreign Application Priority Data
Jun. 21, 2012 (CN) 2012102066714

(51) Int. Cl. G06F 3/0488

(52) U.S. Cl. CPC G06F 3/0488
USPC 715/765

(57) ABSTRACT

A method for editing documents using an electronic device detects a selection operation on a touch panel of the electronic device to obtain a selected object of a document. An editing operation marked on the selected object is obtained. An action is executed corresponding to the editing operation, to manipulate the selected object.

### BACKGROUND

1. Technical Field

The disclosure generally relates to document editing technology; and particularly to an electronic device and method for editing a document using the electronic device.

2. Description of the Related Art

Many electronic devices, such as mobile phones and personal computers, have touch-sensitive screens that can be used for editing operations such as cut, copy, and paste. To edit documents displayed on the touch-sensitive screen, a double-click action can be invoked on the touch-sensitive screen, to select a whole object (e.g., text documents) or a part of the object, and then a user can edit the document. In another way, the user can select the object using a framing gesture, where the framing gesture indicates the object is framed via a window. However, the double-click action or the frame gesture can only select continuous objects, and cannot select discontinuous objects, where the continuous objects indicate characters of the document are arranged one after another, and the discontinuous objects indicate characters of the document are scattered.

Therefore, there is room for improvement within the art.

### BRIEF DESCRIPTION OF THE DRAWINGS

Many aspects of an exemplary electronic device and address book management method can be better understood with reference to the following drawings. The components in the drawings are not necessarily drawn to scale, the emphasis instead being placed upon clearly illustrating the principles of the present embodiments.

FIG. 1 is a block diagram of one embodiment of an electronic device including a document editing system.

FIG. 2 is a schematic diagram of one embodiment of a multi-touch operation on a touch panel of the electronic device of FIG. 1.

FIG. 3 is a schematic diagram of one embodiment of a selection operation on the touch panel of the electronic device of FIG. 1.

FIG. 4 is a schematic diagram of one embodiment of a copy operation on the touch panel of the electronic device of FIG. 1.

FIG. 5 is a flowchart of one embodiment of a document editing method using the document editing system of FIG. 1.

FIG. 6 is a schematic diagram of one embodiment of a cut operation on the touch panel of the electronic device of FIG. 1.

FIGS. 7-8 are schematic diagrams of one embodiment of an inserting operation on the touch panel of the electronic device of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

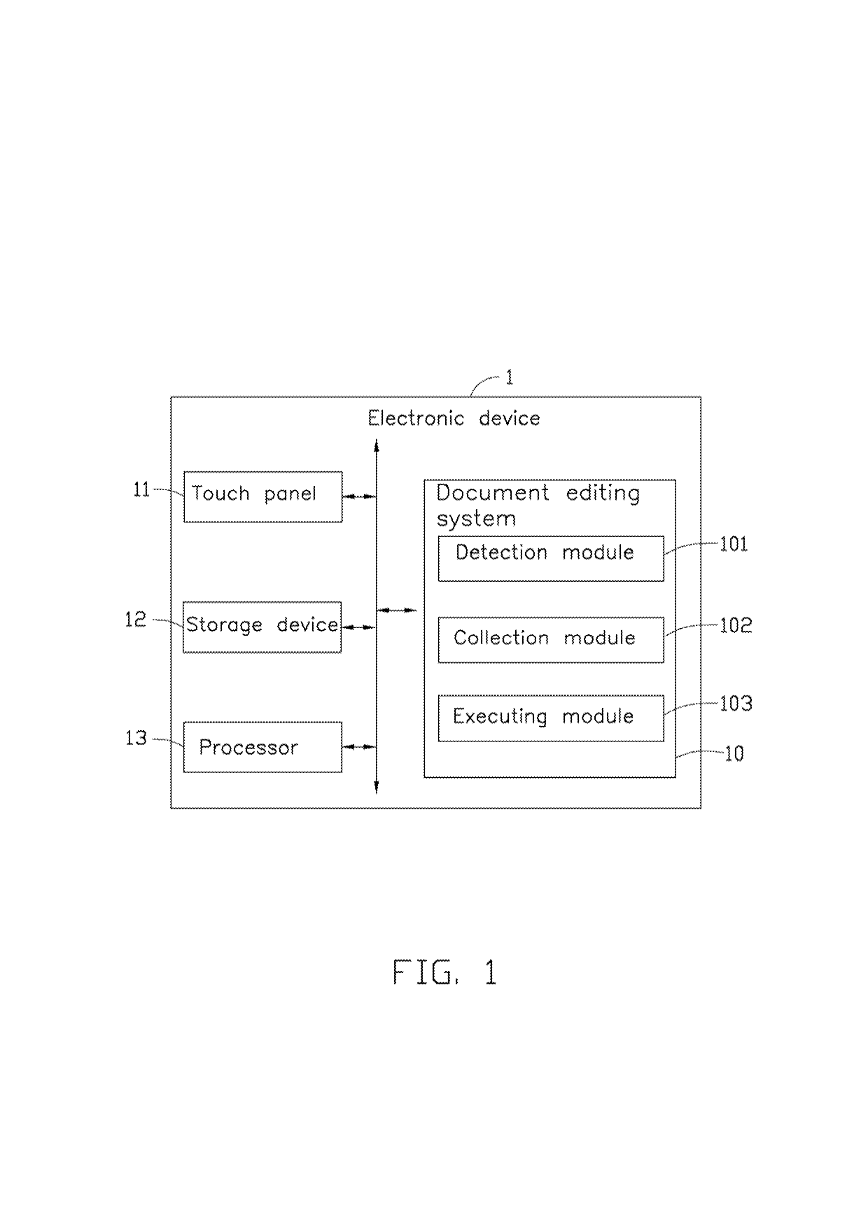

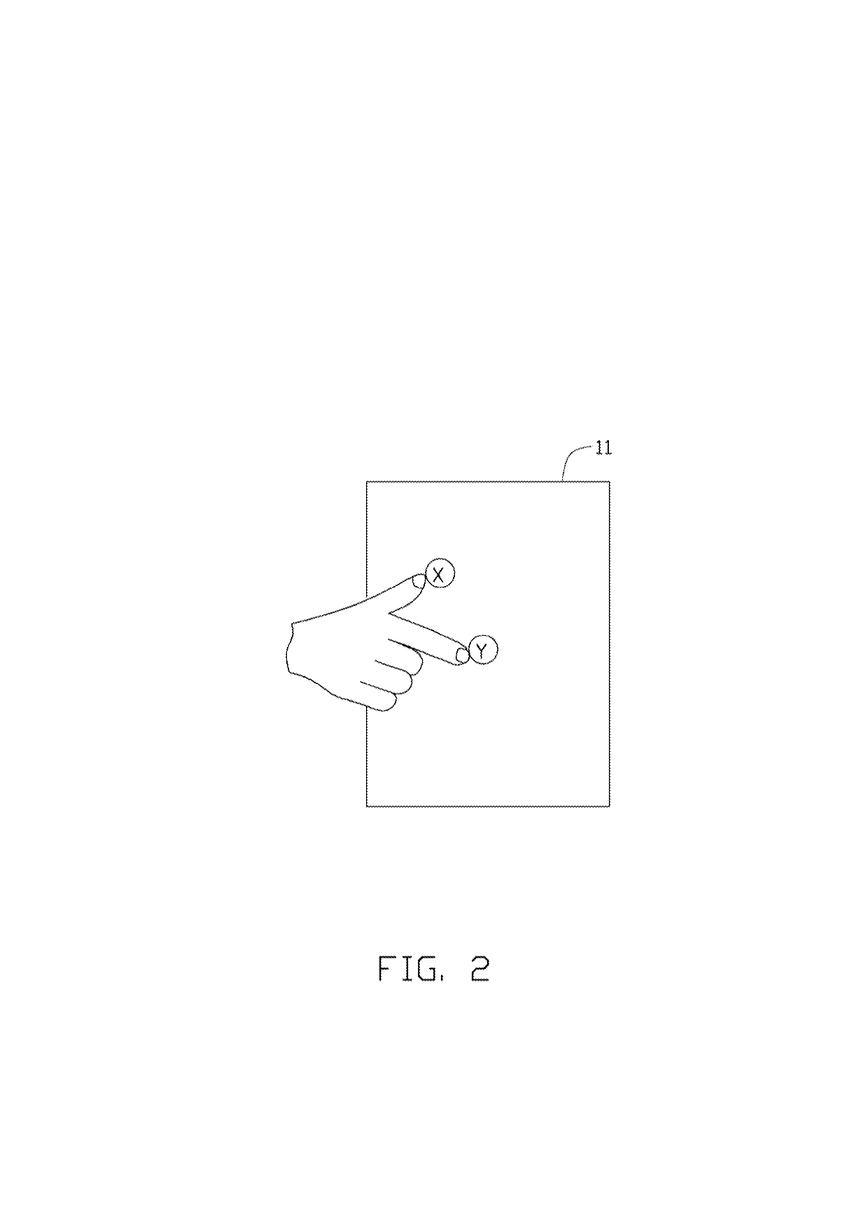

FIG. 1 is a block diagram of one embodiment of an electronic device 1 including a document editing system 10. The electronic device 1 may be a cell phone, a personal digital assistant, a tablet computer, or any other computing device. The electronic device 1 further includes a touch panel 11. The touch panel 11 is used to input and output relevant data, such as images and files, for example. In some embodiments, the touch panel 11 may be a capacitive touch panel or a resistive touch panel that offers multi-touch capability. Multi-touch refers to a touch sensing surface's (e.g., the touch panel 11) ability to recognize presences of two or more points of contact with the surface. As shown in FIG. 2, the touch panel 11 may detect simultaneous contact operations on points X and Y.

The electronic device 1 further includes a storage device 12 providing one or more memory functions, and at least one processor 13. In one embodiment, the document editing system 10 may include computerized instructions in the form of one or more programs, which are stored in the storage device 12 and executed by the processor 12 to perform operations of the electronic device 1.

The storage device 12 stores one or more programs, such as programs of the operating system, other applications of the electronic device 1, and various kinds of documents, such as text documents. In some embodiments, the storage device 12 may include a memory of the electronic device 1 and/or an external storage card, such as a memory stick, a smart media card, a compact flash card, or any other type of memory card. FIG. 1 illustrates only one example of the electronic device 1 that may include more or fewer components than as illustrated, or have a different configuration of the various components.

In one embodiment, the document editing system 10 may include one or more modules, for example, a detection module 101, a collection module 102, and an executing module 103. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

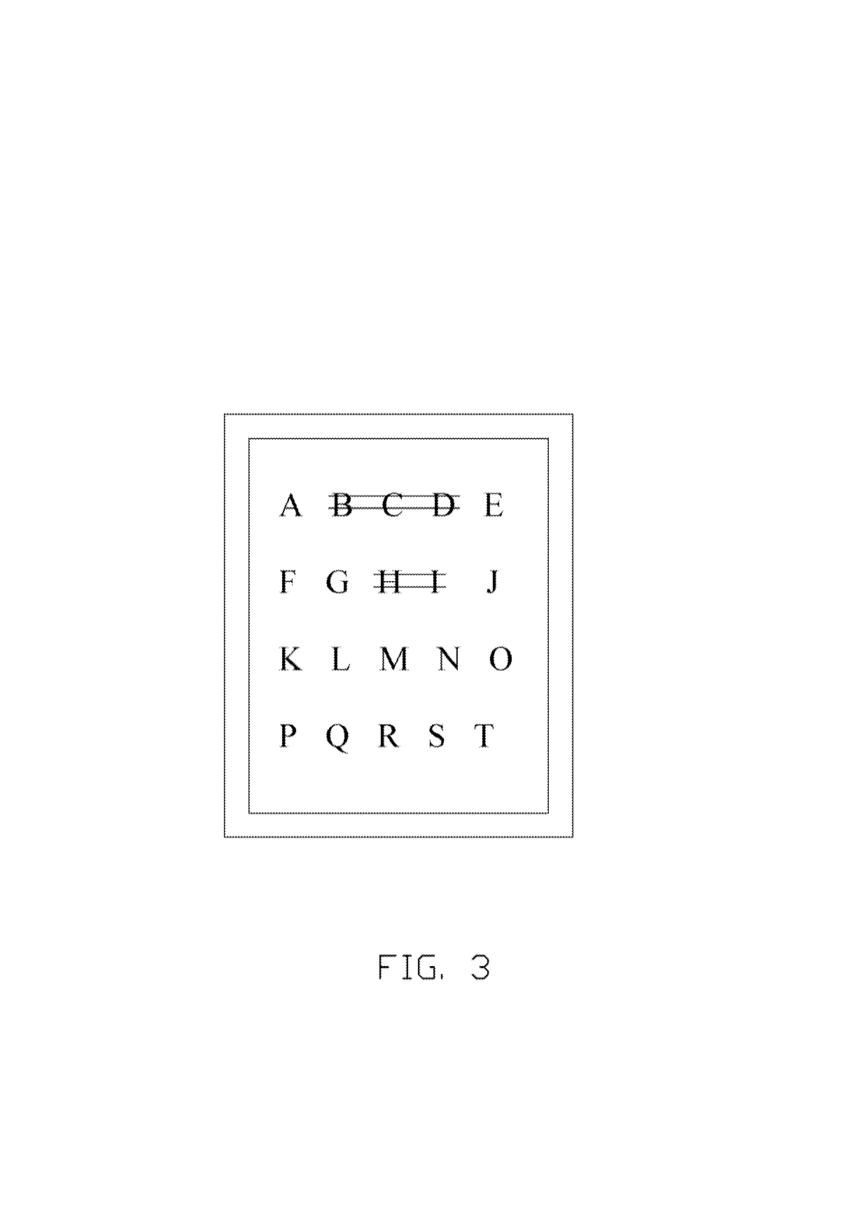

The detection module 101 detects a selection operation (e.g., a touch) on the touch panel 11 to select an object of a document that is displayed on the touch panel 11. The object may be a whole paragraph, a few continuous characters, or a few discontinuous characters, where the continuous characters indicate characters of the document are arranged one after another, and the discontinuous characters indicate characters of the document are scattered. The selection operation may be implemented by performing a selection gesture. In one embodiment, at least two lines serve as the selection gesture. In the selection gesture, a user uses the at least two lines to slide on the touch panel 11 to mark the object. The at least two lines can be parallel to each other or be overlapped, and the at least two lines can be vertically arranged in an up-down direction or can be horizontally arranged in a left-right direction. In FIG. 3, discontinuous characters “BCD” and “HI” distributed in different areas of the document are marked by two lines, and the discontinuous characters “BCD” and “HI” are regarded as being selected.

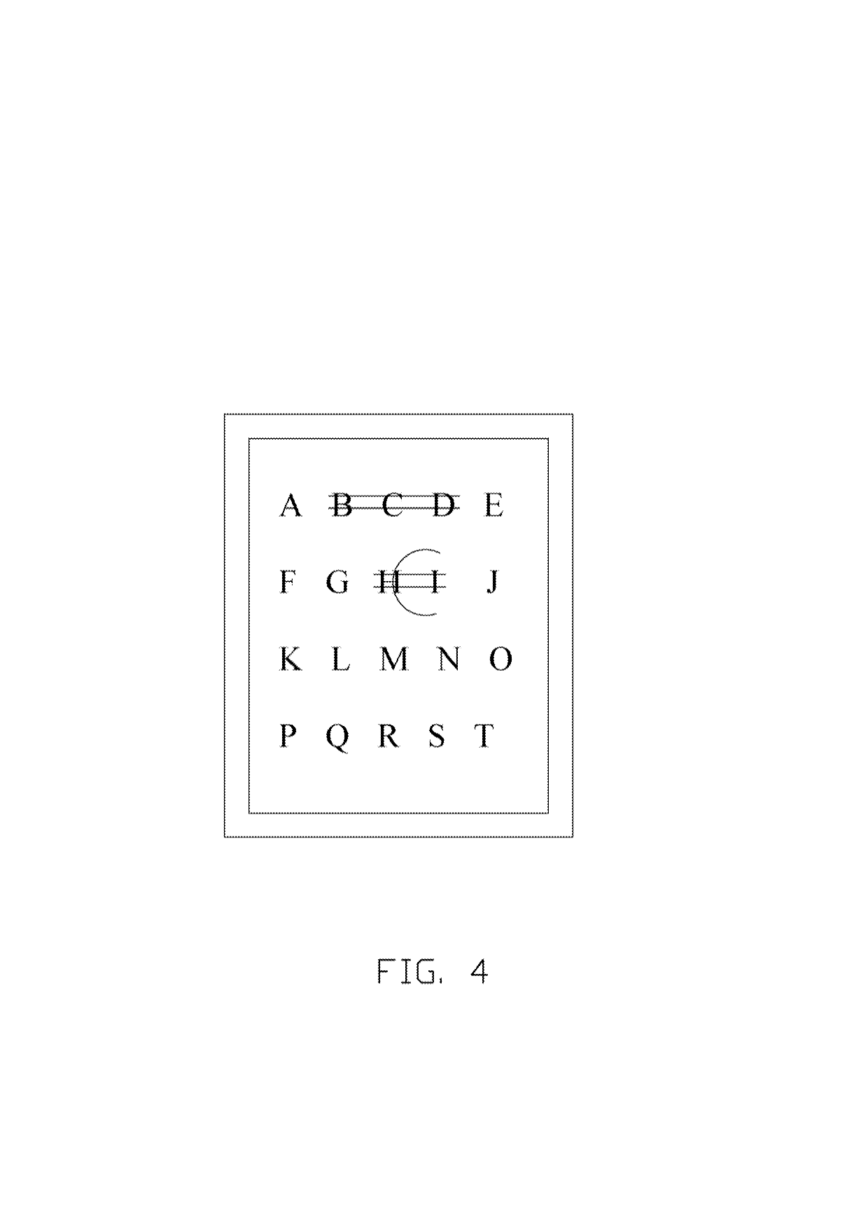

The collection module 102 obtains an editing operation for a selected object on the touch panel 11. The editing operation at least includes a copy operation, a paste operation, a deletion operation, a cut operation, and an inserting operation. The editing operation may be implemented by performing an editing gesture. In one embodiment, the copy operation may be implemented by performing a copy gesture on the selected object, such as a copy gesture “C”, where the copy gesture “C” indicates the user draws the letter C (or an approximation thereof) on the touch panel 11. The deletion operation may be implemented by performing a deletion gesture on the selected object, such as a deletion gesture “D”, where the deletion gesture “D” indicates the user draws the letter D (or an approximation thereof) on the touch panel 11. The cut operation may be implemented by performing a cut gesture on the selected object, such as a cut gesture “X”, where the cut gesture “X” indicates the user draws the letter X (or an approximation thereof) on the touch panel 11. The paste operation may be implemented by performing a paste gesture on a blank area of the document, such as a paste gesture “V”, where the paste gesture “V” indicates the user draws the letter V (or an approximation thereof) on the touch panel 11. The inserting operation may be implemented by performing a inserting gesture on a blank area of the document, such as a inserting gesture “↓”, where the inserting gesture “↓” indicates the user draws a downward facing arrow on the touch panel 11. The user can use the copy gestures “C”, the deletion gestures “D”, or the paste gestures “X” to mark one of the few discontinuous characters, to facilitate manipulation of the object. For example, in FIG. 4, if characters “HI” are marked by the copy gesture “C”, and then the discontinuous characters “BCD” and “HI” are regarded as being needed to be copied.

The executing module 103 pre-stores a plurality of standard symbols, such as “C”, “D”, “X”, “V”, and “↓”. The executing module 103 compares the editing gestures obtained by the collection module 102 with the plurality of standard symbols. If the editing gestures obtained by the collection module 102 are consistent with or similar to the plurality of standard symbols, the executing module 103 executes an action, corresponding to the editing gesture, to manipulate the selected object. For example, when the collection module 102 obtains the deletion gesture “D”, the executing module 103 compares the deletion gesture “D” with the standard symbol “D”. If the deletion gesture “D” is consistent with or similar to the standard symbol “D”, the executing module 103 deletes the selected object, corresponding to the deletion gesture “D”.

Additionally, the executing module 103 de-selects the selected object in response to other editing gestures or actions. For example, when a double-click action is invoked to the selected object, the executing module 103 can de-select the selected object, and then the user can re-select the object of the document.

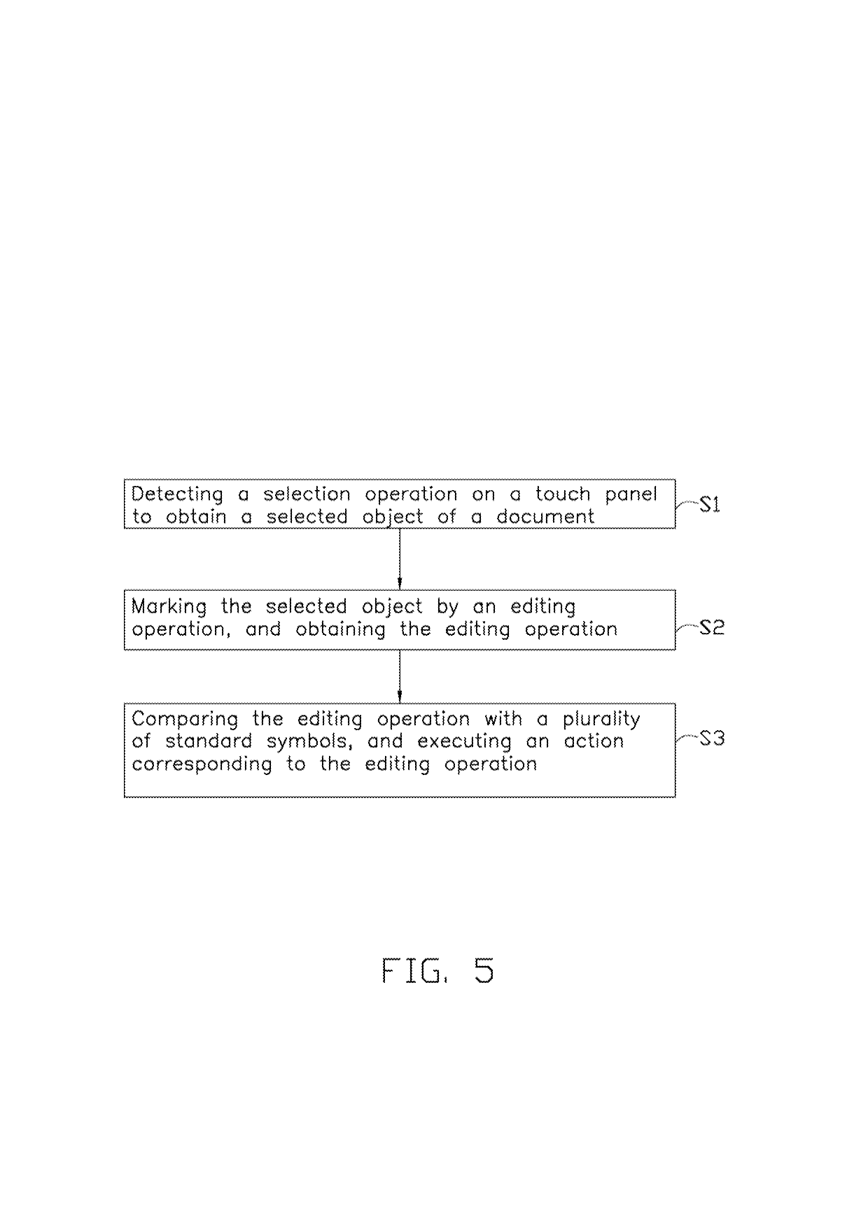

FIG. 5 is a flowchart of one embodiment of a document editing method using the document editing system 10 of FIG. 1. Depending on the embodiment, additional steps may be added, others removed, and the ordering of the steps may be changed.

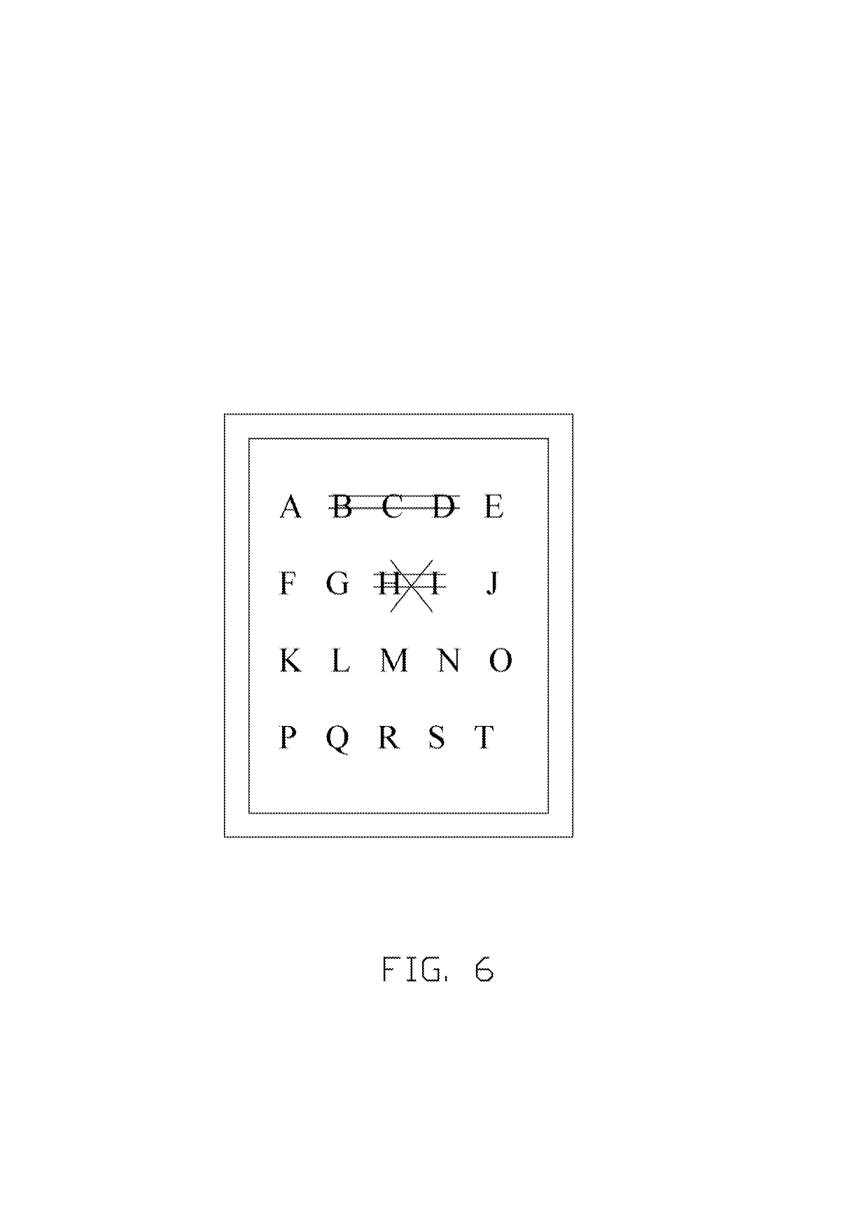

In step S1, the detection module 101 detects the selection gesture on the touch panel 11 to obtain a selected object of the document. For example, in FIG. 6, both of the discontinuous characters “BCD” and “HI” are marked by two lines, and then the detection module 101 determines that the discontinuous characters “BCD” and “HI” have been selected. Thus, the discontinuous characters “BCD” and “HI” are regard as the selected object.

In step S2, the user marks the selected object by an editing operation, and the collection module 102 obtains the editing gesture marked on the selected object. For example, in FIG. 6, the characters “HI” are marked by the cut gesture “X”, and then the collection module 102 determines that the discontinuous characters “BCD” and “HI” are needed to be cut.

In step S3, the executing module 103 compares the editing gestures obtained by the collection module 102 with the plurality of standard symbols, and executes an action, corresponding to the editing gesture, to manipulate the selected object. For example, if the cut gesture “X” is consistent with or similar to the standard symbol “X”, the executing module 103 cuts the selected object corresponding to the cut gesture “X”.

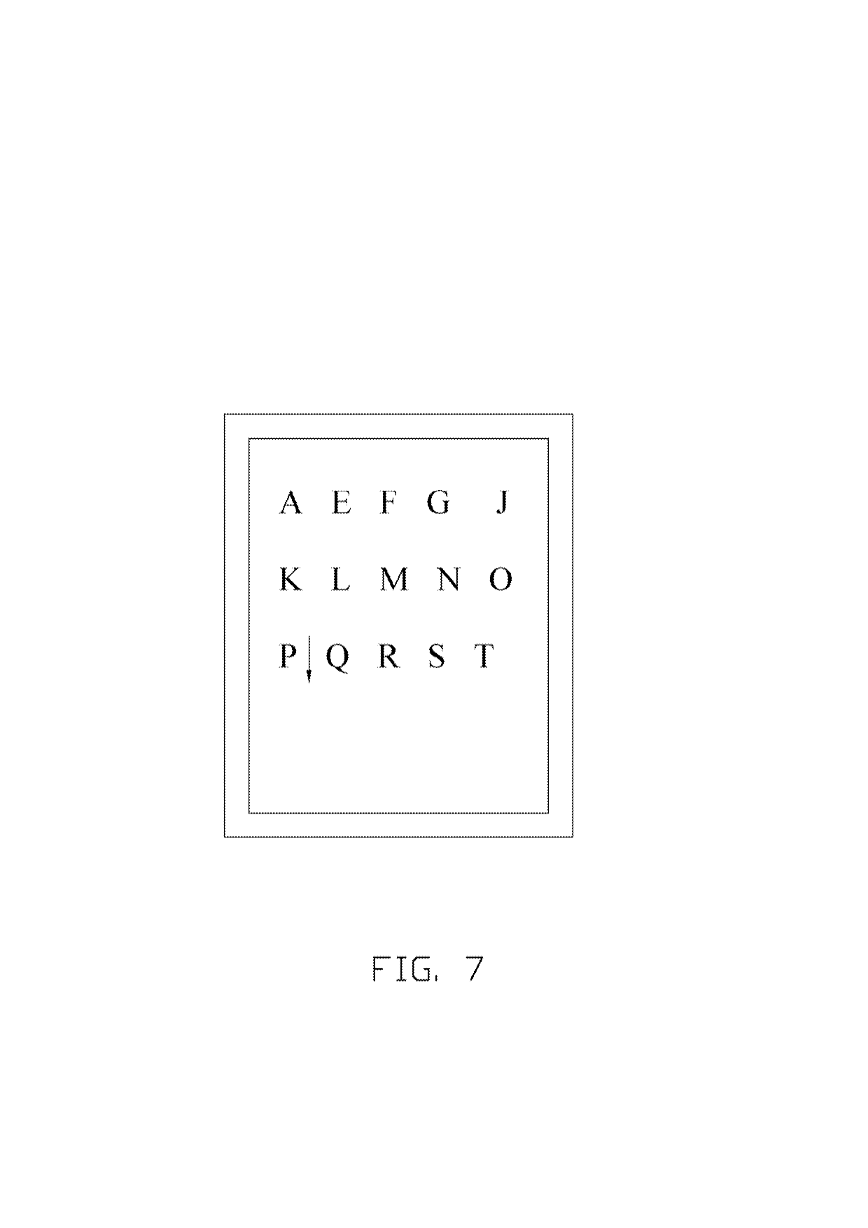

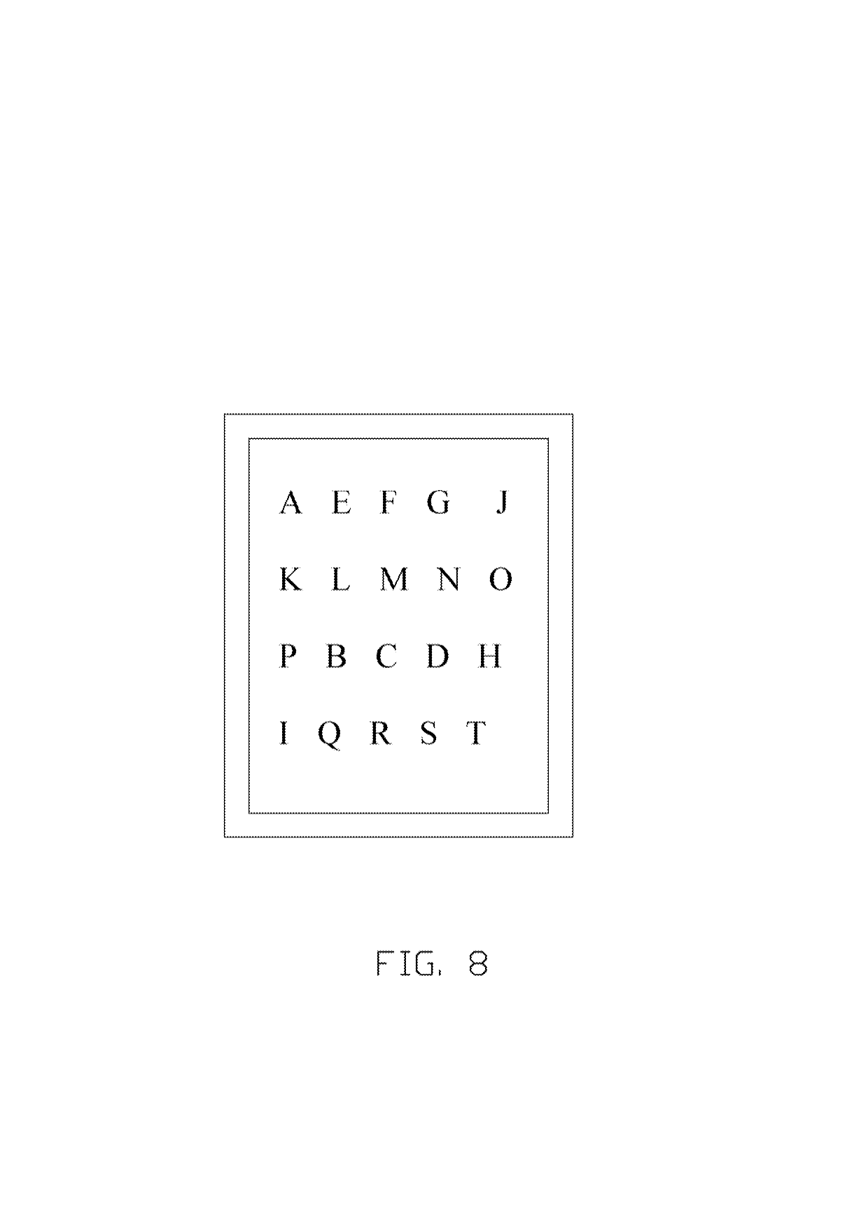

Additionally, in FIGS. 7-8, if the inserting gesture “↓” is marked between a character “P” and a character “Q”, the collection module 102 obtains the inserting gesture “↓”. The executing module 103 compares the inserting gesture “↓” with the standard symbol “↓”. if the inserting gesture “↓” is consistent with or similar to the standard symbol “↓”, the discontinuous characters “BCD” and “HI” are simultaneously inserted between the character “P” and the character “Q”.

In summary, the detection module 101 can detect the selection gesture on the touch panel 11 to select an object of the document, and the collection module 102 can obtain the editing gesture marked on the selected object. Thus, the executing module 103 can execute an action corresponding to the editing gesture. Since the document editing system 10 can manipulate discontinuous objects, thus, it is very convenient for the user to edit the document.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A computer-implemented method for editing documents using an electronic device, the electronic device comprising a touch panel, the method comprising execution of steps comprising:
detecting a selection operation on the touch panel to obtain a selected object of a document displayed on the touch panel;
marking the selected object by an editing operation;
obtaining the editing operation; and
executing an action, corresponding to the editing operation, to manipulate the selected object.

2. The method according to claim 1, wherein the selection operation is implemented by performing a selection gesture, where at least two lines are generated by two sliding operations on the touch panel, and the at least two lines are displayed on the touch panel.

3. The method according to claim 2, wherein the selected object is marked by the at least two lines.

4. The method according to claim 1, wherein the editing operation at least includes a copy operation, a paste operation, a deletion operation, a cut operation, and an inserting operation, and the editing operation is implemented by performing an editing gesture on the touch panel.

5. The method according to claim 4, wherein the copy operation is implemented by drawing an approximation of the letter “C” on the touch panel, the deletion operation is implemented by drawing an approximation of the letter “D” on the touch panel, the cut operation is implemented by drawing an approximation of the letter “X” on the touch panel, the paste operation is implemented by drawing an approximation of the letter “V” on the touch panel, and the inserting operation is implemented by drawing a downward facing arrow on the touch panel.

6. The method according to claim 4, further comprising comparing the editing gesture with a plurality of standard symbols.

7. An electronic device, comprising:
a touch panel;
a storage device;
at least one processor; and
one or more modules that are stored in the storage device and executed by the at least one processor, the one or more modules comprising:
a detection module that detects a selection operation on the touch panel to obtain a selected object of a document displayed on the touch panel;
a collection module that obtains an editing operation marked on the selected object; and
an executing module executes an action, corresponding to the editing operation, to manipulate the selected object.

8. The electronic device according to claim 7, wherein the selection operation is implemented by performing a selection gesture, where at least two lines are generated by two sliding operations on the touch panel, and the at least two lines are displayed on the touch panel.

9. The electronic device according to claim 8, wherein the selected object is marked by the at least two lines.

10. The electronic device according to claim 7, wherein the editing operation at least includes a copy operation, a paste operation, a deletion operation, a cut operation, and an inserting operation, and the editing operation is implemented by performing an editing gesture on the touch panel.

11. The electronic device according to claim 10, wherein the copy operation is implemented by drawing an approximation of the letter “C” on the touch panel, the deletion operation is implemented by drawing an approximation of the letter “D” on the touch panel, the cut operation is implemented by drawing an approximation of the letter “X” on the touch panel, the paste operation is implemented by drawing an approximation of the letter “V” on the touch panel, and the inserting operation is implemented by drawing a downward facing arrow on the touch panel.

12. The electronic device according to claim 11, wherein the executing module compares the editing gesture with a plurality of standard symbols, if the editing gesture is consistent with or similar to the plurality of standard symbols, the executing module executes the action.

13. The electronic device according to claim 11, wherein the executing module de-selects the selected object in response to other editing gestures.

14. A non-transitory storage medium having stored instructions that, when executed by a processor of an electronic device, causes the electronic device to perform a method for editing documents, the electronic device comprising a touch panel, the method comprising:
detecting a selection operation on the touch panel to obtain a selected object of a document displayed on the touch panel;
marking the selected object by an editing operation;
obtaining the editing operation; and
comparing the editing operation with a plurality of standard symbols, and executing an action, corresponding to the editing operation, to manipulate the selected object.

15. The non-transitory storage medium according to claim 14, wherein the selection operation is implemented by performing a selection gesture, where at least two lines are generated by two sliding operations on the touch panel, and the at least two lines are displayed on the touch panel.

16. The non-transitory storage medium according to claim 15, wherein the selected object is marked by the at least two lines.

17. The non-transitory storage medium according to claim 14, wherein the editing operation at least includes a copy operation, a paste operation, a deletion operation, a cut operation, and an inserting operation, and the editing operation is implemented by performing an editing gesture on the touch panel.

18. The non-transitory storage medium according to claim 17, wherein the copy operation is implemented by drawing an approximation of the letter “C” on the touch panel, the deletion operation is implemented by drawing an approximation of the letter “D” on the touch panel, the cut operation is implemented by drawing an approximation of the letter “X” on the touch panel, the paste operation is implemented by drawing an approximation of the letter “V” on the touch panel, and the inserting operation is implemented by drawing a downward facing arrow on the touch panel.
